(19) United States
(12) Patent Application Publication
(10) Pub. No.: US 2025/0218090 A1
(43) Pub. Date: Jul. 3, 2025

(54) BLENDSHAPE WEIGHTS PREDICTED FOR FACIAL EXPRESSION OF HMD WEARER USING MACHINE LEARNING MODEL FOR COHORT CORRESPONDING TO FACIAL TYPE OF WEARER

(71) Applicants: Hewlett-Packard Development Company, L.P., Spring, TX (US); Purdue Research Foundation, West Lafayette, IN (US)

(72) Inventors: Xiaoyu Ji, West Lafayette, IN (US); Jishang Wei, Guilford, CT (US); Yingying Huang, Leander, TX (US); Shibo Zhang, Palo Alto, CA (US); Prahalathan Sundaramoorthy, Palo Alto, CA (US); Fengqing Zhu, West Lafayette, IN (US); Jan P. Allebach, West Lafayette, IN (US); Qian Lin, Palo Alto, CA (US)

(73) Assignees: Hewlett-Packard Development Company, L.P., Spring, TX (US); Purdue Research Foundation, West Lafayette, IN (US)

(21) Appl. No.: 18/867,255

(22) PCT Filed: May 20, 2022
(86) PCT No.: PCT/US2022/030216

§ 371 Date: Nov. 19, 2024

(51) Int. Cl. G06T 13/40; G06T 19/00; G06V 10/82; G06V 40/16

(52) U.S. Cl. CPC G06T 13/40; G06T 19/006; G06V 10/82; G06V 40/176

(57) ABSTRACT

A cohort corresponding to a wearer of a head-mountable display (HMD) is selected from a number of candidate cohorts that each correspond to a different facial type. A set of facial images of the wearer is captured using one or multiple cameras of the HMD. A machine learning model for the selected cohort is applied to the captured set of facial images to predict blendshape weights for the facial expression of the wearer exhibited within the captured set of images. Each candidate cohort has a differently trained machine learning model. The predicted blendshape weights for the facial expression of the wearer are retargeted onto an avatar corresponding to the wearer to render the avatar with the facial expression, and the rendered avatar is displayed.

### BACKGROUND

Extended reality (XR) technologies include virtual reality (VR), augmented reality (AR), and mixed reality (MR) technologies, and quite literally extend the reality that users experience. XR technologies may employ head-mountable displays (HMDs). An HMD is a display device that can be worn on the head. In VR technologies, the HMD wearer is immersed in an entirely virtual world, whereas in AR technologies, the HMD wearer's direct or indirect view of the physical, real-world environment is augmented. In MR, or hybrid reality, technologies, the HMD wearer experiences the merging of real and virtual worlds.

### BRIEF DESCRIPTION OF THE DRAWINGS

FIGS. 1A and 1B are perspective and front view diagrams, respectively, of an example head-mountable display (HMD) that can be used in an extended reality (XR) environment.

FIG. 2 is a diagram of an example process for predicting blendshape weights for a facial expression of the wearer of an HMD from facial images of the wearer captured by the HMD, on which basis an avatar with the wearer's facial expression can be rendered.

FIG. 3 is a diagram of different facial types for which corresponding cohorts have differently trained machine learning models that can be used to predict blendshape weights for facial expressions of HMD wearers.

FIGS. 4A, 4B, and 4C are diagrams of example facial images of the wearer of an HMD captured by the HMD, on which basis blendshape weights for the wearer's facial expression can be predicted.

FIG. 5 is a diagram of an example avatar that can be rendered to have the facial expression of the wearer of an HMD based on blendshape weights predicted for the wearer's facial expression.

FIG. 6 is a diagram of an example process for training machine learning models of cohorts corresponding to different facial types that can be used to predict blendshape weights in FIG. 2.

FIG. 7 is a diagram of example simulated HMD-captured training images of a rendered avatar having a particular facial type, on which basis a machine learning model for predicting blendshape weights can be trained for the cohort corresponding to this facial type.

FIGS. 8A, 8B, and 8C are diagrams of an example machine learning model that can be differently trained for each cohort corresponding to a different facial type.

FIG. 9 is a diagram of an example non-transitory computer-readable data storage medium.

FIG. 10 is a flowchart of an example method.

FIG. 11 is a block diagram of an example HMD.

### DETAILED DESCRIPTION

As noted in the background, a head-mountable display (HMD) can be employed as an extended reality (XR) technology to extend the reality experienced by the HMD's wearer. An HMD can include one or multiple small display panels in front of the wearer's eyes, as well as various sensors to detect or sense the wearer and/or the wearer's environment. Images on the display panels convincingly immerse the wearer within an XR environment, be it a virtual reality (VR), augmented reality (AR), a mixed reality (MR), or another type of XR.

An HMD can include one or multiple cameras, which are image-capturing devices that capture still or motion images. For example, one camera of an HMD may be employed to capture images of the wearer's lower face, including the mouth. Two other cameras of the HMD may be each be employed to capture images of a respective eye of the HMD wearer and a portion of the wearer's face surrounding the eye.

In some XR applications, the wearer of an HMD can be represented within the XR environment by an avatar. An avatar is a graphical representation of the wearer or the wearer's persona, may be in three-dimensional (3D) form, and may have varying degrees of realism, from cartoonish to nearly lifelike. For example, if the HMD wearer is participating in an XR environment with other users wearing their own HMDs, the avatar representing the HMD wearer may be displayed on the HMDs of these other users.

The avatar may be a facial avatar, in that the avatar has a face corresponding to the face of the wearer of the HMD. To represent the HMD wearer more realistically, the avatar may have a facial expression in correspondence with the wearer's facial expression. The facial expression of the HMD wearer thus has to be determined before the avatar can be rendered to exhibit the same facial expression.

A facial expression can be defined by a set of blendshape weights of a facial action coding system (FACS). A FACS taxonomizes human facial movements by their appearance on the face, via values, or weights, for different blendshapes. Blendshapes may also be referred to as facial action units and/or descriptors, and the values or weights may also be referred to as intensities. Individual blendshapes can correspond to particular contractions or relaxations of one or more muscles, for instance. Any anatomically possible facial expression can thus be deconstructed into or coded as a set of blendshape weights representing the facial expression. It is noted that in some instances, facial expressions can be defined using blendshapes that are not specified by the FACS.

Avatars can be rendered to have a particular facial expression based on the blendshape weights of that facial expression. That is, specifying the blendshape weights for a particular facial expression allows for an avatar to be rendered that has the facial expression in question. This means that if the blendshape weights of the wearer of an HMD are able to be identified, an avatar exhibiting the same facial expression as the HMD wearer can be rendered and displayed.

One way to identify the blendshape weights of the wearer of an HMD is to employ a machine learning model that predicts the blendshape weights of the wearer's current facial expression from facial images of the wearer that have been captured by the HMD. The same machine learning model may be employed for predicting the blendshape weights regardless of the wearer of the HMD. However, this can result in the model more accurately predicting blendshape weights for facial expressions of some wearers as compared to other wearers.

For instance, different HMD wearers may have different facial types. The machine learning model, though, may be trained predominantly using training images corresponding to a subset of possible facial types—or even for just one facial type. While the resultantly trained model may accurately predict blendshape weights for facial expressions of HMD wearers having those facial types, it may be less accurate for HMD wearers having other facial types.

Moreover, purposefully expanding the training images so that they include all possible facial types may not result in the trained machine learning model having high accuracy for all facial types. That is, ensuring a diverse set of training images in this respect may improve accuracy of the model for a given facial type as compared to if there were no training images of this facial type. However, the model may be less accurate for another facial type as compared to if there were training images only for that facial type.

Techniques described herein provide for more accurate prediction of blendshape weights for facial expressions of HMD wearers. Rather than a single machine learning model, there are multiple machine learning models for different cohorts corresponding to different facial types. For a particular HMD wearer, the machine learning model for the cohort corresponding to the facial type of the wearer is selected and subsequently used to predicted blendshape weights for that wearer's facial expressions. The machine learning model for each cohort is trained using training images of rendered avatars having the facial type of the cohort in question and having facial expressions corresponding to specified blendshape weights.

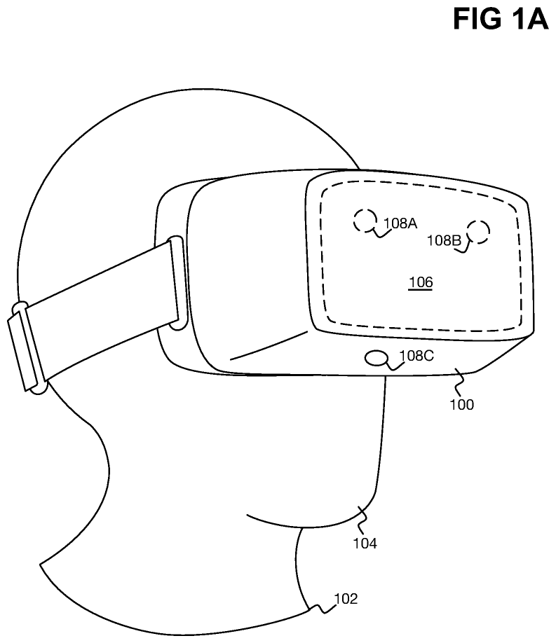

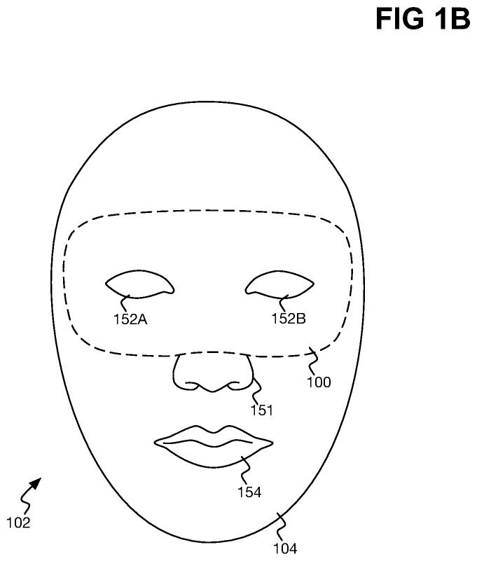

FIGS. 1A and 1B show perspective and front view diagrams of an example HMD 100 worn by a wearer 102 and positioned against the face 104 of the wearer 102 at one end of the HMD 100. Specifically, the HMD 100 can be positioned above the wearer 102′s nose 151 and around his or her right and left eyes 152A and 152B, collectively referred to as the eyes 152 (per FIG. 1B). The HMD 100 can include a display panel 106 inside the other end of the HMD 100 that is positionable incident to the eyes 152 of the wearer 102. The display panel 106 may in actuality include a right display panel incident to and viewable by the wearer 102's right eye 152A, and a left display panel incident to and viewable by the wearer 102's left eye 152B. By suitably displaying images on the display panel 106, the HMD 100 can immerse the wearer 102 within an XR.

The HMD 100 can include eye camera 108A and 108B and/or a mouth camera 108C, which are collectively referred to as the cameras 108C. While just one mouth camera 108C is shown, there may be multiple mouth cameras 108C. Similarly, whereas just one eye camera 108A and one eye camera 108B are shown, there may be multiple eye cameras 108A and/or multiple eye cameras 108B. The cameras 108 capture images of different portions of the face 104 of the wearer 102 of the HMD 100, on which basis the blendshape weights for the facial expression of the wearer 102 can be predicted.

The eye cameras 108A and 108B are inside the HMD 100 and are directed towards respective eyes 152. The right eye camera 108A captures images of the facial portion including and around the wearer 102's right eye 152A, whereas the left eye camera 108B captures images of the facial portion including and around the wearer 102's left eye 152B. The mouth camera 108C is exposed at the outside of the HMD 100, and is directed towards the mouth 154 of the wearer 102 (per FIG. 1B) to capture images of a lower facial portion including and around the wearer 102's mouth 154.

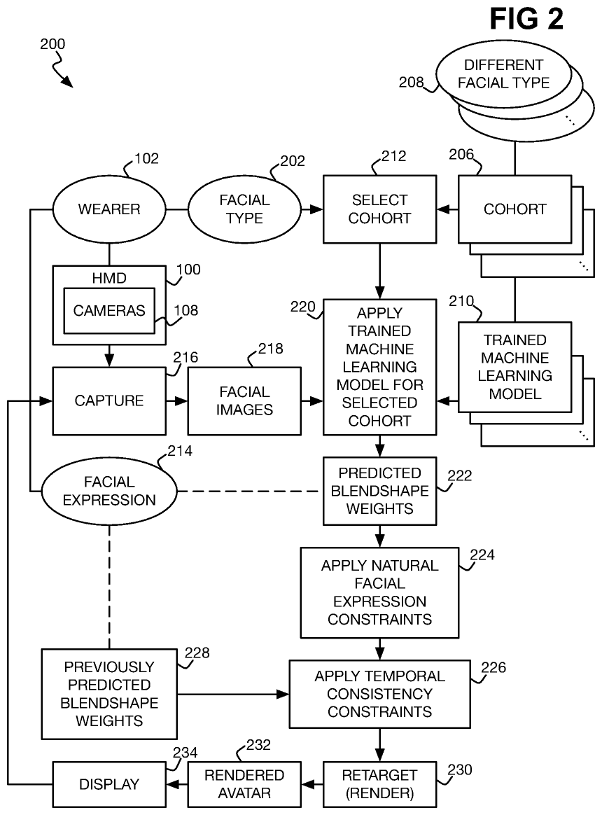

FIG. 2 shows an example process 200 for predicting blendshape weights for the facial expression of the wearer 102 of the HMD 100, which can then be retargeted onto an avatar corresponding to the wearer 102's face to render the facial avatar with a corresponding facial expression. The wearer 102 has a particular facial type 202. There are cohorts 206 that respectively corresponding to different facial types 208. Different example facial types are described later in the detailed description.

The cohorts 206 further respectively have differently trained machine learning models 210. The machine learning model 210 for each cohort 206 is trained using training images of rendered avatars having the facial type 208 of the cohort 206 in question and having facial expressions corresponding to specified blendshape weights, as described later in the detailed description. That the machine learning models 210 for the cohorts 206 are differently trained can mean that, although the model 210 is of the same general type and may be trained in the same manner, the models 210 are each trained on different training images.

A cohort 206 is selected (212) that corresponds to a facial type 208 matching the facial type 202 of the HMD wearer 102. This cohort 206 can be selected in a variety of different manners. In one implementation, the wearer 102 him or herself may select the facial type 208 of the cohort 206 to which his or her facial type 202 corresponds. For example, the wearer 102 may be presented with all the facial types 208, and asked to select the facial type 208 that best corresponds to his or her facial type 202. Receiving wearer selection of the facial type 208 thus results in selection of the cohort 206 corresponding to this facial type 208.

In another implementation, a classifier, such as a trained classifier machine learning model (not to be confused with the machine learning models 210) may be employed to identify the facial type 208 of the cohort 206 to which the facial type 202 of the wearer 102 corresponds. For example, the wearer 102 may be requested to present a neutral facial expression 214. The cameras 108 of the HMD 100 then capture (216) a set of facial images 218 of the wearer 102 of the HMD 100 (i.e., a set of images 218 of the wearer 102's face 104) when exhibiting the neutral facial expression 214. The classifier machine learning model can then be applied to these images 218 to identify the facial type 208 corresponding to the wearer 102's facial type, and thus select the cohort 206 having the identified facial type 208.

Once a cohort 206 has been selected (212), the cameras 108 of the HMD 100 continue to capture facial images 218 of the wearer 102 as the wearer changes his or her facial expression 214. The trained machine learning model 210 for the selected cohort 206 is applied (220) to the facial images 218 to predict blendshape weights 222 for the wearer 102's facial expression 214. That is, the set of facial images 218 is input into the trained machine learning model 210 in question, with the model 210 then outputting predicted blendshape weights 222 for the facial expression 214 of the wearer 102 based on the facial images 218.

In one implementation, natural facial expression constraints may then be applied to the predicted blendshape weights 222 (224). Application of the natural facial expression constraints ensure that the predicted blendshape weights 222 do not correspond to an unnatural facial expression unlikely to be exhibitable by any HMD wearer, including the wearer 102. The natural facial expression constraints may be encoded in a series of heuristic-based rules or as a probabilistic graphical model that can be applied to the actual predicted blendshape weights. The natural facial expression constraints, in other words, ensure that the predicted blendshape weights 222 do not correspond to a facial anatomy that is likely to be impossible for the face of any HMD wearer to have in actuality.

In one implementation, temporal consistency constraints may also be applied (226) to the predicted blendshape weights 222. The temporal consistency constraints are applied to the blendshape weights 222 that have been currently predicted in comparison to previously predicted blendshape weights 228 to ensure that the blendshape weights 222 do not correspond to an unnatural change in facial expression unlikely to be exhibitable by any HMD wearer, including the wearer 102. The temporal consistency constraints may be encoded using a heuristic technique, such as an exponential interpolation-based history prediction technique.

For instance, the blendshape weights 222 of the HMD wearer 102 may be predicted a number of times, continuously over time, from different sets of facial images 218 respectively captured by the cameras 108 of the HMD 100. Each time the blendshape weights 222 are predicted from a set of facial images 218, the natural facial expression constraints may be applied. Further, each time the blendshape weights 222 are predicted, the temporal consistency constraints may be applied to ensure that the currently predicted blendshape weights 222 do not represent an unrealistic if not impossible sudden change in facial anatomy of any HMD wearer in actuality, as compared to the previously predicted blendshape weights 228 for the wearer 102.

Therefore, application of the natural facial expression constraints and the temporal consistency constraints ensures that the blendshape weights 222 more accurately reflect the actual facial expression 214 of the HMD wearer 102. The natural facial expression constraints may consider just the currently predicted blendshape weights 222, and not any previously predicted blendshape weights 228. By comparison, the temporal consistency weights consider the currently predicted blendshape weights 222 in comparison to previously predicted blendshape weights 228.

The predicted blendshape weights 222 for the facial expression 214 of the wearer 102 of the HMD 100 can then be retargeted (230) onto a (facial) avatar corresponding to the face 104 of the wearer 102 to render the avatar with this facial expression 214. (The natural facial expression and/or the temporary consistency constraints are thus applied prior to retargeting.) The result of blendshape weight retargeting is thus a rendered avatar 232 for the wearer 102. The avatar 232 has the same facial expression 214 as the wearer 102 insofar as the predicted blendshape weights 222 accurately reflect the wearer 102's facial expression 214. The avatar 232 is rendered from the predicted blendshape weights 222 in this respect, and thus has a facial expression corresponding to the blendshape weights 222.

The rendered avatar 232 for the wearer 102 of the HMD 100 may then be displayed (234). For example, the avatar 232 may be displayed on the HMDs worn by other users who are participating in the same XR environment as the wearer 102. If the blendshape weights 222 are predicted by the HMD 100 or by a host device, such as a desktop or laptop computer, to which the HMD 100 is communicatively coupled, the HMD 100 or host device may thus transmit the rendered avatar 232 to the HMDs or host devices of the other users participating in the XR environment. In another implementation, however, the HMD 100 may itself display the facial avatar 232.

The process 200 can then be repeated with the capture (216) of the next set of facial images 218. In general, however, the selection (212) of the cohort 206 corresponding to the facial type 208 matching the facial type 202 of the wearer 102 may be performed just one, and not repeated. The cohort 206 may be reselected (212), though, if the wearer 102 is not satisfied with the accuracy of the rendered avatar 232's facial expression matching or tracking the wearer 102′s actual facial expression 214.

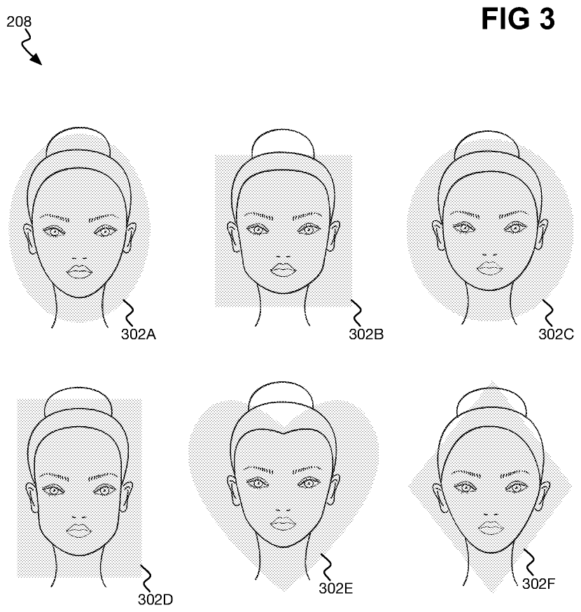

FIG. 3 shows different example facial types 208 to which the cohorts 206 can respectively correspond. In the example, the facial types 208 correspond to different facial shapes. Other facial types 208 may also be considered, in addition to or in lieu of facial shape. For example, lip shape and size, eye shape and size, nose shape and size, and the relative or absolute locations of the lips, the eyes, and the nose may be considered as or as part of facial type. As another example, skin color, ethnicity, and/or race may be considered as part of facial type.

In the example, the facial types 208 specifically include an oval facial shape 302A, a square facial shape 302B, a round facial shape 302C, a rectangular facial shape 302D, a heart facial shape 302E, and a diamond facial shape 302F. However, the facial types 208 may include other facial shapes as well, in addition to or in lieu of the facial shapes 302A, 302B, 302C, 302D, 302E, and 302F. Examples of such other facial shapes include the pear facial shape, which is also referred to as a triangular face, and which is characterized by a small or narrow forehead and a larger jawline.

The oval facial shape 302A is longer than wide, with a jaw that is narrower than the cheekbones. The square facial shape 302B is characterized by a wide hairline and jawline. The round facial shape 302C is characterized by a wide hairline and fullness below the cheekbones. The rectangular facial shape 302D, which may also be referred to as the oblong facial shape, is characterized by a very long and narrow bone structure. The heart facial shape 302E shape is characterized by a wider forehead and narrower chin. The diamond face shape 302F is characterized by a narrow chin and forehead with wide cheekbones.

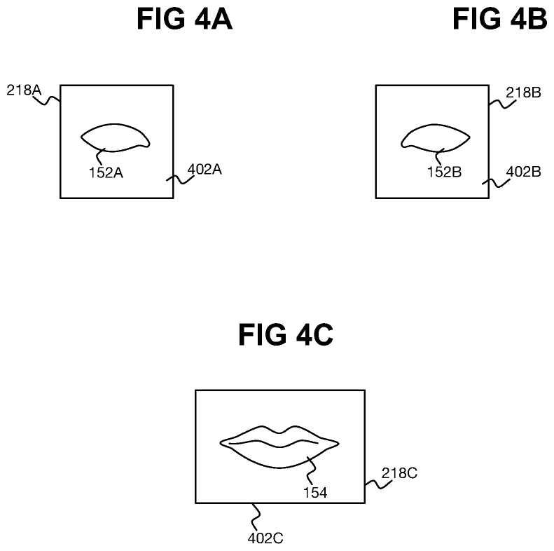

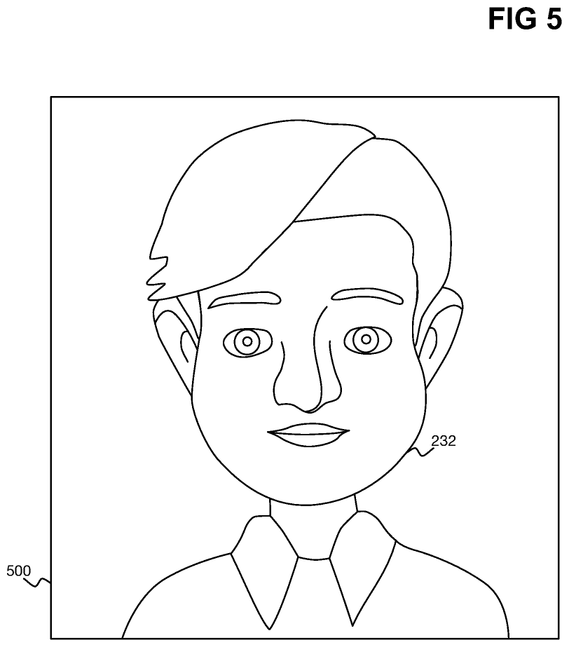

FIGS. 4A, 4B, and 4C show an example set of HMD-captured images 218A, 218B, and 218C, respectively, which are collectively referred to as and can constitute the images 218 to which the trained machine learning model 210 for the selected cohort 206 is applied to generate predicted blendshape weights 222. The image 218A is of a facial portion 402A including and surrounding the wearer 102's right eye 152A, whereas the image 218B is of a facial portion 402B including and surrounding the wearer 102's left eye 152B. The image 218C is of a lower facial portion 402C including and surrounding the wearer 102's mouth 154. FIGS. 4A, 4B, and 4C thus show examples of the types of images that can constitute the set of facial images 218 used to predict the blendshape weights 222.

FIG. 5 shows an example image 500 of a (facial) avatar 232 that can be rendered when retargeting the predicted blendshape weights 222 onto the facial avatar 232. In the example, the avatar 232 is a two-dimensional (2D) avatar, but it can also be a 3D avatar. The facial avatar 232 is rendered from the predicted blendshape weights 222 for the wearer 102's currently exhibited facial expression 214. Therefore, to the extent that the predicted blendshape weights 22 accurately encode the facial expression 214 of the wearer 102, the facial avatar 232 has the same facial expression 214 as the wearer 102.

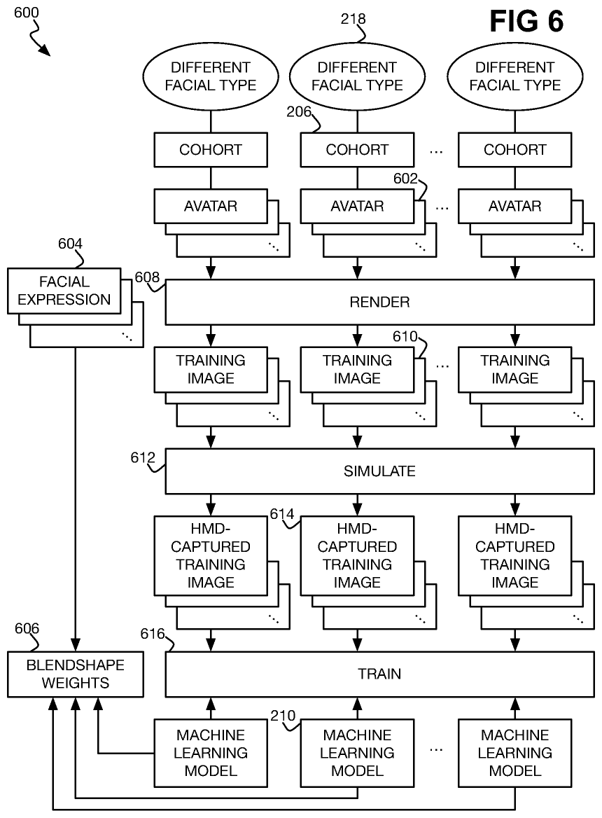

FIG. 6 shows an example process 600 for differently (i.e., separately) training the machine learning model 210 of each cohort 206 corresponding to a different facial type 208. Each cohort 206 has a set of different (facial) avatars 602 having the facial type 208 to which the cohort 206 corresponds. Each avatar 602 of each cohort 206 is rendered (608) with different facial expressions 604 that each have specified blendshape weights 606, resulting in a collection of avatar training images 610 for each cohort 206. That is, the blendshape weights 606 for each facial expression 604 are retargeted onto each avatar 602 of each cohort 206 to result in the training images 610. For example, each cohort 206 may have a set of M avatars 602.

There may also be a set of N facial expressions 604 that each have specified blendshape weights 606. Therefore, the result is a set of M×N training images 610 for each cohort 206—i.e., N training images 610 for each avatar 602 of each cohort 206. Rendering of an avatar 602 based on specified blendshape weights 606 results in the avatar 602 exhibiting the facial expression 604 having or corresponding to these blendshape weights 606. The resulting training image 610 of the avatar 602 is known to correspond to the specified blendshape weights 606, since the avatar 602 was rendered based on the blendshape weights 606.

To increase the diversity of the training images 610 for each cohort 206, training images 610 may be randomly selected and flipped from left to right. The specified blendshape weights 606 for the facial expression 604 of each selected training image 610 are similarly exchanged from left to right (e.g., the blendshape weights 606 for mouth smile left are exchanged with those for mouth smile right, and so on). In one implementation, there may be seven base facial expressions 604, including smile (both sides), smile (left side), smile (right side), frown, mouth move left, mouth move right, and mouth pucker.

For each avatar training image 610 of each avatar 602 of each cohort 206, a set of HMD-captured avatar training images 614 can be simulated (612). The HMD-captured training images 614 for a training image 610 simulate how an actual HMD, such as the HMD 100, would capture the face of an avatar 602 if the avatar 602 were a real person wearing the HMD 100. The simulated HMD-captured training images 614 can thus correspond to actual HMD-captured facial images 218 of an actual HMD wearer 102 in that the images 614 can be roughly of the same size and resolution as and can include comparable or corresponding facial portions to those of the actual images 218.

A machine learning model 210 for each cohort 206 is then trained (616) based on the simulated HMD-captured avatar training images 614 (i.e., more generally the avatar training images 610) for the cohort 206 in question and the blendshape weights 606 on which basis the training images 614 were rendered. Each model 210 is trained so that it accurately predicts the blendshape weights 606 from the simulated HMD-captured training images 614. Since each machine learning model 210 is trained based on different avatar training images 610, it is said that each model 210 is differently (i.e., separately) trained.

Each machine learning model 210 may be a convolutional neural network having convolutional layers followed by a pooling layer that generate, identify, or extract image features to predict blendshape weights from input images. Examples include different versions of the MobileNet machine learning model. The MobileNet machine learning model is described in A. Howard et al., “MobileNets: Efficient Convolutional Neural Networks for Mobile Vision Applications,” arXiv: 1704.04861 [cs.CV], April 2017; M. Sandler et al. “MobileNetV2: Inverted Residuals and Linear Bottlenecks,” arXiv: 1801.104381 [cs.CV], March 2019; and A. Howard et al., “Search for MobileNetV3,” arXiv: 1905.02244 [cs.CV], November 2019.

Each machine learning model 210 may be trained to minimize a loss value between the specified blendshape weights 606, which can be referred to as the ground truth weights, and the predicted blendshapes weights output by the model 210. For example, the loss value that is minimized can be the mean squared error (MSE). MSE is calculated by squaring the difference between a model 210's predictions and the ground truth, and then averaging the difference over the entire training dataset.

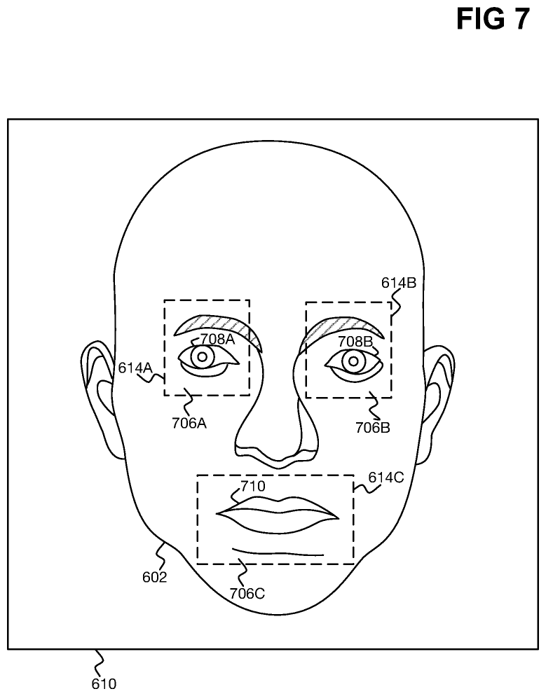

FIG. 7 shows an example avatar training image 610 of a (facial) avatar 602 of a cohort 206 corresponding to the square facial shape 302B as its facial type 208. That is, the avatar 602 has a square facial shape 302B. The facial avatar 602 is a 3D avatar, and the more lifelike the avatar 602 is, the more accurate the resultantly trained machine learning model 210 may be. FIG. 6 also shows example HMD-captured avatar training images 614A, 614B, and 614C that are simulated from the training image 610 and that can be collectively referred to as the simulated HMD-captured training avatar images 614 on which basis the machine learning model 210 can be actually trained.

The simulated HMD-captured training image 614A is of a facial portion 706A surrounding and including the avatar 602's left eye 708A, whereas the image 614B is of a facial portion 706B surrounding and including the avatar 602's right eye 708B. The training images 614A and 614B are thus left and right eye avatar training images that are simulated in correspondence with actual left and right eye images that can be captured by an HMD, such as the images 218A and 218B of FIGS. 4A and 4B, respectively. That is, the training images 614A and 614B may be of the same size and resolution and capture the same facial portions as actual HMD-captured left and right eye images.

The simulated HMD-captured training image 614C is of a lower facial portion 706C surrounding and including the avatar 602's mouth 710. The training image 614C is thus a mouth avatar training image that is simulated in correspondence with an actual mouth image captured by an HMD, such as the image 218C of FIG. 4C. Similarly, then, the training image 614C may be of the same size and resolution and capture the same facial portion as an actual HMD-captured mouth image.

In general, the avatar training images 610 match the perspective and image characteristics of the facial images of HMD wearers captured by the actual cameras of the HMDs on which basis a machine learning model 210 will be used to predict the wearers' facial expressions. That is, the avatar training images 610 are in effect captured by virtual cameras corresponding to the actual HMD cameras. The avatar training images 614 of FIG. 7 that have been described reflect just one particular placement of such virtual cameras. More generally, then, depending on the actual HMD cameras used to predict facial expressions of HMD wearers, the avatar training images 610 can vary in number and placement.

For example, the HMD mouth cameras may be stereo cameras so that more of the wearers' cheeks may be included within the correspondingly captured facial images, in which case the avatar training images 610 corresponding to such facial images would likewise capture more of the rendered avatars' cheeks. As another example, the HMD cameras may also include forehead cameras to capture facial images of the wearers' foreheads, in which case the avatar training images 610 would include corresponding images of the rendered avatars' foreheads. As a third example, there may be multiple eye cameras to capture the regions surrounding the wearers' eyes at different oblique angles, in which case the avatar training images 610 would also include corresponding such images.

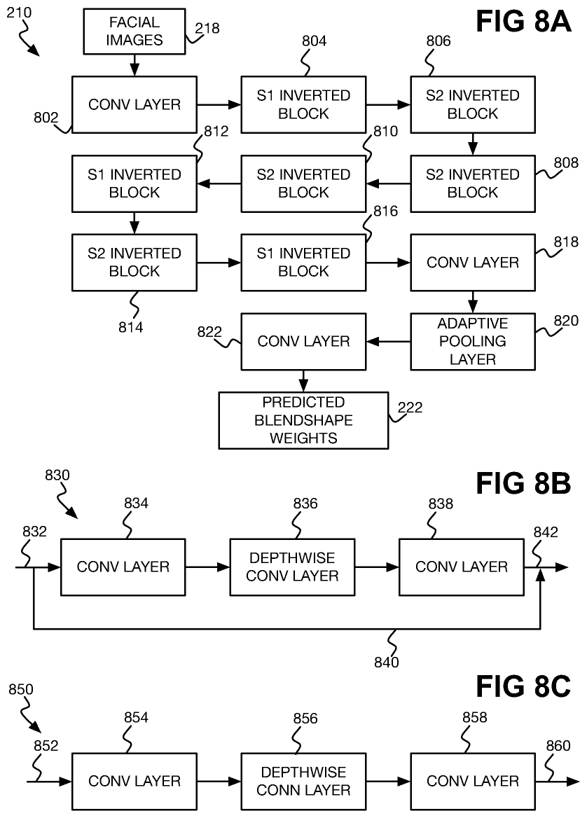

FIGS. 8A, 8B, and 8C show an example machine learning model 210 that can be trained per the process 600 to predict blendshape weights 222 from captured facial images 218 of an HMD wearer 102 in the process 200. The machine learning model 210 is a specific implementation of a convolutional neural network. For instance, the machine learning model 210 can be a specific implementation of the MobileNet machine learning model reference above. The machine learning model 210 is for a specific cohort 206, depending on the particular facial type 208 of the avatar training images 610 on which the model 210 was trained.

Per FIG. 8A, the facial images 218 input to the machine learning model 210 are provided to a convolutional layer 802, which is followed by an inverted block 804 having a stride of one. Three inverted blocks 806, 808, and 810 that each have a stride of two follow the inverted block 804, in order. There is then another inverted block 812 having a stride of one, followed by inverted block 814 having a stride of two and still another inverted block 816 having a stride of one. A convolutional layer 818 follows, and then an adaptive pooling layer 820 and a final convolutional layer 822, which outputs the predicted blendshape weights 222.

Per FIG. 8B, an inverted block 830 having a stride of one is depicted that can implement each of the inverted blocks 804, 812, and 816 of FIG. 8A. A convolutional layer 834, a depthwise convolutional layer 836, and another convolutional layer 838 are applied to the input 832 of the inverted block 830, in order. There is also a skip connection 840 connecting the input 832 to the output 842 of the inverted block 830.

Per FIG. 8C, an inverted block 850 having a stride of two is depicted that can implement each of the inverted blocks 806, 808, 810, and 814 of FIG. 8A. A convolutional layer 854, a depthwise convolutional layer 856, and another convolutional layer 858 are applied to the input 852 of the inverted block 850, in order. However, unlike the inverted block 830 of FIG. 8B, there is no skip connection connecting the input 852 to the output 860 of the inverted block 850.

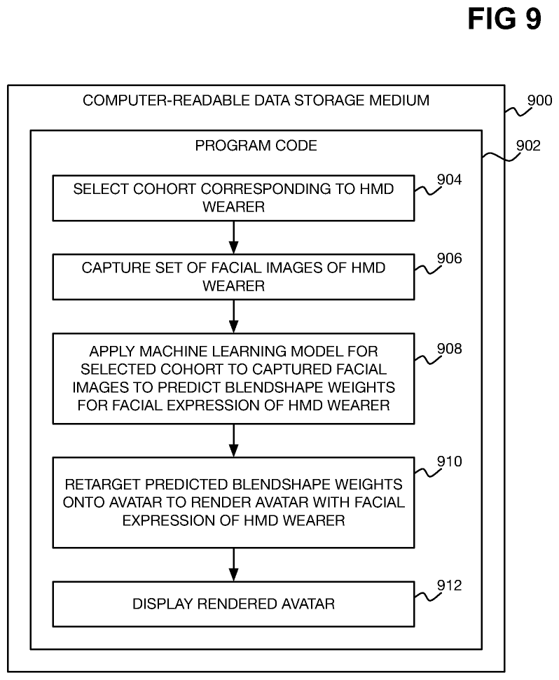

FIG. 9 shows an example non-transitory computer-readable data storage medium 900 storing program code 902 executable by a processor to perform processing. The data storage medium 900 may be a semiconductor memory or another type of data storage medium. The processor may be that of the HMD 100, in which case the HMD 100 performs the processing, or it may be that of a host device to which the HMD 100 is connected. The processing includes selecting a cohort 206 corresponding to a wearer 102 of the HMD 100 from a number of candidate cohorts 206 that each correspond to a different facial type 208 (904). The processing includes capturing a set of facial images 218 of the wearer 102 using one or multiple cameras 108 of the HMD 100 (906).

The processing includes applying a machine learning model 210 for the selected cohort 206 to the captured set of facial images 218 to predict blendshape weights 222 for the facial expression 214 of the wearer 102 exhibited within the captured set of images 218 (908). Each candidate cohort 206 has a differently trained machine learning model 210. The processing includes retargeting the predicted blendshape weights 222 for the facial expression 214 of the wearer 102 onto an avatar 232 corresponding to the wearer 102 to render the avatar 232 with the facial expression 214 (910). The processing includes displaying the rendered avatar 232 (912).

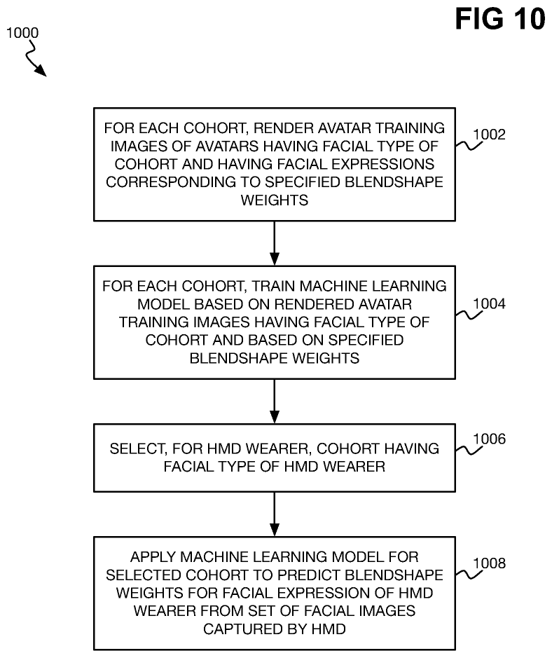

FIG. 10 shows an example method 1000. The method 1000 may be implemented as program code stored on a non-transitory computer-readable data storage medium and executed by a processor. The processor may be that of the HMD 100, in which case the HMD 100 performs the method 1000, or it may be that of a host device to which the HMD 100 is communicatively connected, in which case the host device performs the method 1000. The method 1000 includes, for each of a number of cohorts 206 that each correspond to a different facial type 208, rendering avatar training images 610 of avatars 602 having the different facial type 208 of the cohort 206 and having facial expressions 604 corresponding to specified blendshape weights 606 (1002).

The method 1000 includes, for each cohort, training a machine learning model 210 based on the rendered avatar training images 610 of the avatars 602 having the different facial type 208 of the cohort 206 and based on the specified blendshape weights 606 (1004). The method 1000 includes selecting, for a wearer 102 of the HMD 100, the cohort 206 having the different facial type 208 to which the facial type 202 of the wearer 102 corresponds (1006). The method 1000 includes applying the machine learning model 210 for the selected cohort 206 to predict blendshape weights 222 for a facial expression 214 of the wearer 102 from a set of facial images 218 captured by the HMD 100 of the wearer 102 when exhibiting the facial expression 214 (1008).

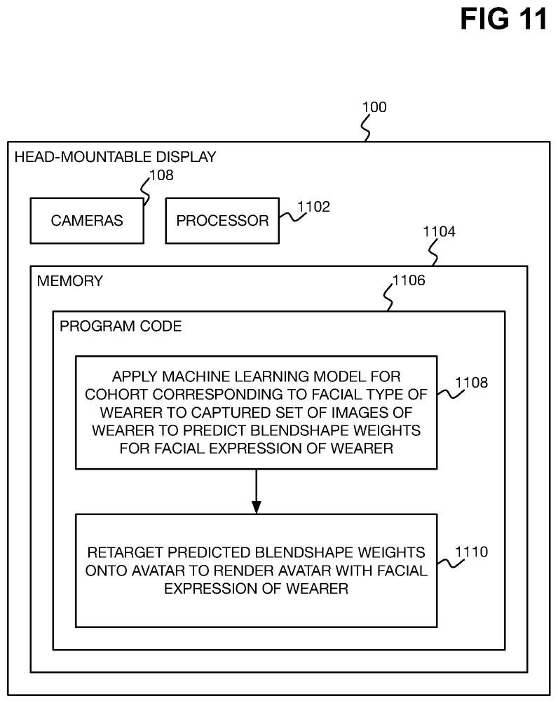

FIG. 11 shows the example HMD 100. The HMD 100 includes one or multiple cameras 108 to capture a set of images 218 of a face 104 of a wearer 102 of the HMD 100. The HMD 100 includes a processor 1102 and a memory 1104, which can be a non-transitory computer-readable data storage medium, storing program code 1106 executable by the processor 1102. The processor 1102 and the memory 1104 may be integrated within an application-specific integrated circuit (ASIC) in the case in which the processor 1102 is a special-purpose processor. The processor 1102 may instead be a general-purpose processor, such as a central processing unit (CPU), in which case the memory 1104 may be a separate semiconductor or other type of volatile or non-volatile memory 1104. The HMD 100 may include other components as well, such as the display panel 106, various sensors, and so on.

The program code 1106 is executable by the processor 1102 to apply a machine learning model 210 for a cohort 206 corresponding to a facial type 202 of the wearer 102 to the captured set of images 218 to predict blendshape weights 222 for a facial expression 214 of the wearer 102 exhibited within the captured set of images 218 (1108). The program code 1106 is executable by the processor to retarget the predicted blendshape weights 222 for the facial expression 214 of the wearer 102 onto an avatar 232 corresponding to the wearer 102 to render the avatar 232 with the facial expression 214 (1110).

Techniques have been described for predicting blendshape weights for facial expressions of HMD wearers using machine learning models. The machine learning model that is used for a particular HMD wearer corresponds to a facial type matching the wearer's facial type, and is trained on rendered training images of avatars having this facial type. The resulting blendshape weight prediction is more accurate than if the same machine learning model were used for wearers of different facial types.

We claim:

1. A non-transitory computer-readable data storage medium storing program code executable by a processor to perform processing comprising:
selecting a cohort corresponding to a wearer of a head-mountable display (HMD) from a plurality of candidate cohorts that each correspond to a different facial type;
capturing a set of facial images of the wearer using one or multiple cameras of the HMD;
applying a machine learning model for the selected cohort to the captured set of facial images to predict blendshape weights for a facial expression of the wearer exhibited within the captured set of images, each candidate cohort having a differently trained machine learning model;
retargeting the predicted blendshape weights for the facial expression of the wearer onto an avatar corresponding to the wearer to render the avatar with the facial expression; and
displaying the rendered avatar.

2. The non-transitory computer-readable data storage medium of claim 1, wherein the differently trained machine learning model for each candidate cohort is trained on facial training images of the different facial type to which the candidate cohort corresponds.

3. The non-transitory computer-readable data storage medium of claim 1, wherein the different facial type to which each candidate cohort corresponds is a different one of a plurality of facial shapes.

4. The non-transitory computer-readable data storage medium of claim 3, wherein the facial shapes comprise an oval facial shape, a square facial shape, a round facial shape, a diamond facial shape, a rectangular facial shape, a heart facial shape, and a diamond facial shape.

5. The non-transitory computer-readable data storage medium of claim 1, wherein selecting the cohort corresponding to the wearer from the candidate cohorts comprises:
receiving wearer selection of the different facial type of the candidate cohort corresponding to a facial type of the wearer.

6. The non-transitory computer-readable data storage medium of claim 1, wherein selecting the cohort corresponding to the wearer from the candidate cohorts comprises:
applying a classifier machine learning model to the captured set of facial images of the wearer to identify the different facial type of the candidate cohort to which a facial type of the wearer corresponds.

7. The non-transitory computer-readable data storage medium of claim 1, wherein the processing further comprises, prior to retargeting the predicted blendshape weights for the facial expression of the wearer onto the avatar corresponding to the wearer:
applying natural facial expression constraints to the predicted blendshape weights to ensure that the predicted blendshape weights do not correspond to an unnatural facial expression unlikely to be exhibitable by the wearer.

8. The non-transitory computer-readable data storage medium of claim 1, wherein the set of facial images of the wearer are captured, the machine learning for the selected cohort is applied to the captured set of images to predict the blendshape weights, the predicted blendshape weights are retargeted onto the avatar to render the avatar, and the rendered avatar is displayed continuously over time,
and wherein each of a plurality of times the blendshape weights are predicted, the processing further comprises, prior to retargeting the predicted blendshape weights for the facial expression of the wearer onto the avatar corresponding to the wearer:
applying temporal consistency constraints to the predicted blendshape weights as currently predicted in comparison to as previously predicted to ensure that the predicted blendshape weights do not correspond to an unnatural change in facial expression unlikely to be exhibitable by the wearer.

9. A method comprising:
for each of a plurality of cohorts that each correspond to a different facial type, rendering avatar training images of avatars having the different facial type of the cohort and having facial expressions corresponding to specified blendshape weights;
for each cohort, training a machine learning model based on the rendered avatar training images of the avatars having the different facial type of the cohort and based on the specified blendshape weights;
selecting, for a wearer of a head-mountable display (HMD), the cohort having the different facial type to which a facial type of the wearer corresponds; and
applying the machine learning model for the selected cohort to predict blendshape weights for a facial expression of the wearer from a set of facial images captured by the HMD of the wearer when exhibiting the facial expression.

10. The method of claim 9, further comprising:
retargeting the predicted blendshape weights for the facial expression of the wearer onto an avatar corresponding to the wearer to render the avatar with the facial expression;
displaying the rendered avatar.

11. The method of claim 9, wherein the set of facial images captured by the HMD of the wearer comprise left and right eye images of facial portions of the wearer respectively including left and right eyes of the wearer and a mouth image of a lower facial portion of the wearer including a mouth of the wearer, the method further comprising:
for each avatar training image of an avatar having a facial expression, simulating left and right eye avatar training images in correspondence with the left and right eye images captured by the HMD and a mouth avatar training image in correspondence with the mouth image captured by the HMD,
and wherein, for each cohort, the machine learning model is trained using the left and right eye avatar training images and the mouth avatar training image simulated for each avatar training image of an avatar having the different facial type of the cohort.

12. The method of claim 9, wherein selecting, for the wearer, the cohort having the different facial type to which the facial type of the wearer corresponds comprises:
receiving wearer selection of the different facial type of the cohort corresponding to the facial type of the wearer; or
applying a classifier machine learning model to the set of facial images of the wearer to identify the different facial type of the cohort to which the facial type of the wearer corresponds.

13. The method of claim 9, wherein the different facial type to which each cohort corresponds is a different one of a plurality of facial shapes comprising an oval facial shape, a square facial shape, a round facial shape, a diamond facial shape, a rectangular facial shape, a heart facial shape, and a diamond facial shape.

14. A head-mountable display (HMD) comprising:
one or multiple cameras to capture a set of images of a wearer of the HMD;
a processor; and
a memory storing program code executable by the processor to:
apply a machine learning model for a cohort corresponding to a facial type of the wearer to the captured set of images to predict blendshape weights for a facial expression of the wearer exhibited within the captured set of images; and
retarget the predicted blendshape weights for the facial expression of the wearer onto an avatar corresponding to the wearer to render the avatar with the facial expression.

15. The HMD of claim 14, wherein the cohort is selected from a plurality of candidate cohorts each corresponding to a different facial type and each having a differently trained machine learning model to predict the blendshape weights.
